(19) United States
(12) Patent Application Publication
(10) Pub. No.: US 2006/0209015 A1
(43) Pub. Date: Sep. 21, 2006

(54) Optical navigation system

(76) Inventors: David C. Feldmeier, Redwood City, CA (US); Michael J. Brosnan, Fremont, CA (US); Tong Xie, San Jose, CA (US)

Correspondence Address: AVAGO TECHNOLOGIES, LTD., P.O. BOX 1920, DENVER, CO, 80201-1920, US

(21) Appl. No.: 11/083,837

(22) Filed: Mar. 18, 2005

(51) Int. Cl. G09G 5/00

(52) U.S. Cl. 345/156

(57) ABSTRACT

An optical navigation system. The optical navigation system includes an image sensor capable of optical coupling to a surface of an object, a data storage device, and a navigation circuit. The image sensor includes multiple photosensitive elements with the number of photosensitive elements disposed in a first direction greater than the number of photosensitive elements disposed in a second direction. The second direction is perpendicular to the first direction. The image sensor is capable of capturing successive images of areas of the surface, the areas located along an axis parallel to the first direction. The data storage device is capable of storing the captured images. The navigation circuit includes a first digital circuit for determining an estimate for the relative displacement between the image sensor and the object along the axis obtained by comparing the image captured subsequent to the displacement to the image captured previous to the displacement.

### REFERENCE TO RELATED APPLICATIONS

The subject matter of the instant Application is related to that of U.S. Pat. No. 6,433,780 by Gordon et al., entitled “Seeing Eye Mouse for a Computer System” issued 13 Aug. 2002 and assigned to Agilent Technologies, Inc. This Patent describes a basic technique for reducing the amount of computation needed for cross-correlation, which techniques include components of the representative embodiments described below. Accordingly, U.S. Pat. No. 6,433,780 is hereby incorporated herein by reference.

### BACKGROUND

One of the most common and, at the same time, useful input devices for user control of modern computer systems is the mouse. The main goal of a mouse as an input device is to translate the motion of an operator's hand into signals that the computer can use. This goal is accomplished by displaying on the screen of the computer's monitor a cursor which moves in response to the user's hand movement. Commands which can be selected by the user are typically keyed to the position of the cursor. The desired command can be selected by first placing the cursor, via movement of the mouse, at the appropriate location on the screen and then activating a button or switch on the mouse.

Positional control of cursor placement on the monitor screen was initially obtained by mechanically detecting the relative movement of the mouse with respect to a fixed frame of reference, i.e., the top surface of a desk or a mouse pad. A common technique is to use a ball inside the mouse which in operation touches the desktop and rolls when the mouse moves. Inside the mouse there are two rollers which touch the ball and roll as the ball rolls. One of the rollers is oriented so that it detects motion in a nominal X direction, and the other is oriented 90 degrees to the first roller so it detects motion in the associated Y direction. The rollers are connected to separate shafts, and each shaft is connected to a separate optical encoder which outputs an electrical signal corresponding to movement of its associated roller. This signal is appropriately encoded and sent typically as binary data to the computer which in turn decodes the signal it received and moves the cursor on the computer screen by an amount corresponding to the physical movement of the mouse.

More recently, optical navigation techniques have been used to produce the motion signals that are indicative of relative movement along the directions of coordinate axes. These techniques have been used, for instance, in optical computer mice and fingertip tracking devices to replace conventional mice and trackballs, again for the position control of screen pointers in windowed user interfaces for computer systems. Such techniques have several advantages, among which are the lack of moving parts that accumulate dirt and that suffer from mechanical wear when used.

Distance measurement of movement of paper within a printer can be performed in different ways, depending on the situation. For printer applications, we can measure the distance moved by counting the number of steps taken by a stepper motor, because each step of the motor will move a certain known distance. Another alternative is to use an encoding wheel designed to measure relative motion of the surface whose motion causes the wheel to rotate. It is also possible to place marks on the paper that can be detected by sensors.

Motion in a system using optical navigation techniques is measured by tracking the relative displacement of a series of images. First, a two dimensional view of an area of the reference surface is focused upon an array of photo detectors, whose outputs are digitized and stored as a reference image in a corresponding array of memory. A brief time later a second image is digitized. If there has been no motion, then the image obtained subsequent to the reference image and the reference image are essentially identical. If, on the other hand, there has been some motion, then the subsequent image will have been shifted along the axis of motion with the magnitude of the image shift corresponding to the magnitude of physical movement of the array of photosensors. The so called optical' mouse used in place of the mechanical mouse for positional control in computer systems employ this technique.

In practice, the direction and magnitude of movement of the optical mouse can be measured by comparing the reference image to a series of shifted versions of the second image. The shifted image corresponding best to the actual motion of the optical mouse is determined by performing a cross-correlation between the reference image and each of the shifted second images with the correct shift providing the largest correlation value. Subsequent images can be used to indicate subsequent movement of the optical mouse using the method just described.

At some point in the movement of the optical mouse, however, the image obtained which is to be compared with the reference image may no longer overlap the reference image to a degree sufficient to be able to accurately identify the motion that the mouse incurred. Before this situation can occur it is necessary for one of the subsequent images to be defined as a new reference image. This redefinition of the reference image is referred to as re-referencing.

Measurement inaccuracy in optical navigation systems is a result of the manner in which such systems obtain their movement information. Optical navigation sensors operate by obtaining a series of images of an underlying surface. This surface has a micro texture. When this micro texture is illuminated (typically at an angle) by a light, the micro texture of the surface results in a pattern of shadows that is detected by the photosensor array. A sequence of images of these shadow patterns are obtained, and the optical navigation sensor attempts to calculate the relative motion of the surface that would account for changes in the image. Thus, if an image obtained at time t(n+1) is shifted left by one pixel relative to the image obtained at time t(n), then the optical navigation sensor most likely has been moved right by one pixel relative to the observed surface.

As long as the reference frame and current frame overlap by a sufficient amount, movement can be calculated with sub-pixel accuracy. However, a problem occurs when an insufficient overlap occurs between the reference frame and the current frame, as movement cannot be determined accurately in this case. To prevent this problem, a new reference frame is selected whenever overlap between the reference frame and the current frame is less than some threshold. However, because of noise in the optical sensor array, the sensor will have some amount of error introduced into the measurement of the amount of movement each time the reference frame is changed. Thus, as the size of the measured movement increases, the amount of error will increase as more and more new reference frames are selected.

Due to the lack of absolute positional reference, at each re-referencing, any positional errors from the previous re-referencing procedure are accumulated. When the optical mouse sensor travels over a long distance, the total cumulative position error built up can be significant. If the photosensor array is 30×30, re-referencing may need occur each time the mouse moves 15 pixels or so (15 pixels at 60 microns per pixel=one reference frame update every 0.9 mm). The amount of measurement error over a given distance is proportional to E*(N)^{1/2}, where E is the error per reference frame change, and N is the number of reference frame updates.

### SUMMARY

In a representative embodiment, the optical navigation system comprises an image sensor capable of optical coupling to a surface of an object, a data storage device, and a navigation circuit. The image sensor comprises multiple photosensitive elements with the number of photosensitive elements disposed in a first direction being greater than the number of photosensitive elements disposed in a second direction. The second direction is perpendicular to the first direction. The image sensor is capable of capturing successive images of areas of the surface, the areas being located along an axis parallel to the first direction. The data storage device is capable of storing the captured images, and the navigation circuit comprises a first digital circuit for determining an estimate for the relative displacement between the image sensor and the object along the axis obtained by comparing the image captured subsequent to the displacement to the image captured previous to the displacement.

In another representative embodiment, an optical navigation system comprises a first image sensor capable of optical coupling to a surface of an object, a second image sensor capable of optical coupling to the surface separated by a distance in a first direction from the first image sensor, a data storage device, and a navigation circuit. The first and second image sensors are capable of capturing successive images of areas of the surface, wherein the areas are located along an axis parallel to the first direction. The data storage device is capable of storing the captured images, and the navigation circuit comprises a first digital circuit for determining an estimate for the relative displacement between the image sensor and the object along the axis obtained by comparing the images captured subsequent to the displacement to the images captured previous to the displacement.

In still another representative embodiment, an optical navigation system comprises a large image sensor capable of optical coupling to a surface of an object, a data storage device, and a navigation circuit. The large image sensor comprises an array of pixels having a total active area of at least 2,000 microns by 2,000 microns. The large image sensor is capable of capturing successive images of areas of the surface. The data storage device is capable of storing successive images captured by the first large image sensor, and the large image sensor is capable of capturing at least one image before and one set of images after relative movement between the object and the large image sensor. The navigation circuit is capable of comparing successive images captured and stored by the large sensor with at least one stored image captured by the large image sensor and obtaining a surface offset distance between compared images having a degree of match greater than a preselected value.

In yet another representative embodiment, a method comprises capturing a reference image of an area of a surface, storing the captured reference image in a data storage device, capturing a new image by the image sensor, storing the new image in the data storage device, comparing the new image with the reference image, and computing the distance moved from the reference image based on the results of the step comparing the new image with the reference image. The image is captured by an image sensor, wherein the image sensor comprises multiple photosensitive elements. The number of photosensitive elements disposed in a first direction is greater than the number of photosensitive elements disposed in a second direction, wherein the second direction is perpendicular to the first direction. The image sensor is capable of capturing successive images of areas of the surface, wherein the areas are located along an axis parallel to the first direction. The above steps are repeated as appropriate.

In an additional representative embodiment, a method comprises capturing a reference first image of an area of a surface by a first image sensor, capturing an associated second image of another area of the surface by a second image sensor, storing the captured set of images in a data storage device, capturing a set of new images by the first and second image sensors, storing the captured set of new images in the data storage device, comparing the new images with the reference first image, and computing the distance moved from the reference image based on the results of the step comparing the new images with the previous reference image. The above steps are repeated as appropriate.

Other aspects and advantages of the representative embodiments presented herein will become apparent from the following detailed description, taken in conjunction with the accompanying drawings.

### BRIEF DESCRIPTION OF THE DRAWINGS

The accompanying drawings provide visual representations which will be used to more fully describe various representative embodiments and can be used by those skilled in the art to better understand them and their inherent advantages. In these drawings, like reference numerals identify corresponding elements.

FIG. 1 is a drawing of a block diagram of an optical navigation system as described in various representative embodiments.

FIG. 2A is a drawing of a navigation surface as described in various representative embodiments.

FIG. 2B is another drawing of the navigation surface of FIG. 2A.

FIG. 2C is yet another drawing of the navigation surface of FIG. 2A.

FIG. 2D is still another drawing of the navigation surface of FIG. 2A.

FIG. 3A is a drawing of a block diagram of another optical navigation system as described in various representative embodiments.

FIG. 3B is a drawing of a block diagram of part of still another optical navigation system as described in various representative embodiments.

FIG. 3C is a drawing of a block diagram of an image sensor as described in various representative embodiments.

FIG. 3D is a drawing of a more detailed block diagram of part of the optical navigation system of FIG. 3A.

FIG. 4 is a diagram showing placement in time and location of images of a surface as described in various representative embodiments.

FIG. 5A is a flow chart of a method for using the optical navigation system as described in various representative embodiments.

FIG. 5B is a more detailed flow chart of part of the method of FIG. 5A.

FIG. 6A is a drawing of a block diagram of a three image sensor optical navigation system as described in various representative embodiments. FIG. 6B is a drawing of a block diagram of a four image sensor optical navigation system as described in various representative embodiments.

### DETAILED DESCRIPTION

As shown in the drawings for purposes of illustration, the present patent document discloses a novel optical navigation system. Previous systems capable of optical navigation have had limited accuracy in measuring distance. In representative embodiments, optical navigation systems are disclosed which provide for increased movement of the sensors before re-reference is required with a resultant increase in the accuracy obtainable.

In the following detailed description and in the several figures of the drawings, like elements are identified with like reference numerals.

As previously indicated, optical navigation sensors are used to detect the relative motion of an illuminated surface. In particular, an optical mouse detects the relative motion of a surface beneath the mouse and passes movement information to an associated computer. The movement information contains the direction and amount of movement. While the measurement of the amount of movement has been considered generally sufficient for purposes of moving a cursor, it may not be accurate enough for other applications, such as measurement of the movement of paper within a printer.

Due to the lack of absolute positional reference, at each re-referencing, any positional errors from the previous re-referencing procedure accumulate. As the mouse sensor travels over a long distance, the total cumulative position error built up can be significant, especially in printer and other applications.

Thus, one way to improve measurement accuracy is to increase the amount of motion that can be measured between reference frame updates while maintaining the same error per reference frame. Increasing the size of the photosensor array will reduce the number of reference frame updates. If the size increase reduces the reference frame updates by a factor of four, the overall improvement to the system is a factor of two as the error is proportional to the square root of the number of re-references that has occurred. If the direction of anticipated movement is known, the size of the photosensor array need only be increased in that direction. The advantage of increasing the array size along only one axis is a reduction in the size of the chip that contains the photosensor array with the resultant higher manufacturing yield because there are fewer photosensors that can fail.

If motion occurs in more than one direction, multiple measurement systems can be used, one for each direction of motion. For example, if movement can occur in the X direction and the Y direction, then two measurement systems can be used, one for X direction movement and the other for Y direction movement.

If multiple measurement systems are used, individual photosensors may be a part of more than one system. For example, rather than two independent 20×40 arrays of photosensors having a total of 1600 photosensors, an alternative is to share a 20×20 array of photosensors between the two measurement systems. Thus, one 20×40 array consists of a first 20×20 array plus the 20×20 shared array, and the other 20×40 array consists of a second 20×20 array plus the 20×20 shared array which would result in a total of only 1200 photosensors which represents a 25% reduction in the number of photosensors.

In a traditional mouse, the reference frame and the sample frame both are obtained from the same photosensor array. If motion occurs along a known path, then two separate photosensor arrays can be used to increase the time between reference frame updates. Unidirectional motion is measured along the path between the upstream photosensor array and the downstream photosensor array. If motion occurs in two directions at separate times, two image sensors aligned in one of the directions of motion can be used to measure displacement in that direction and another image sensor aligned with one of the other image sensors in the other direction of motion can be used to measure displacement in that other direction of motion. Alternatively, two separate pairs of image sensors (four image sensors) can be used wherein each pair of image sensors is used to separately measure displacement in each of the two directions of movement.

For ease of description, assume that the distance between the centers of the two photosensor arrays is 10 mm. When the system first begins to operate, the downstream photosensor array is used for optical navigation as usual. This means that both the sample frame and the reference frame are obtained from the downstream photosensor array. However, at the same time, the upstream photosensor array takes a series of reference frame images that are stored in a memory. Once the motion measurement circuitry of the downstream sensor estimates that the underlying navigation surface has moved approximately 10 mm, the downstream sensor uses the reference frame captured by the upstream sensor. Thus, the reference frame from the upstream sensor is correlated with sample frames from the downstream sensor. This situation allows the system to update the reference frame once for every 10 mm or so of motion.

Thus, the total amount of motion measured in mm is 10*A+0.9*B, where A is the number of 10 mm steps measured using reference frames from the upstream sensor and B is the number of 0.9 mm steps measured since the last 10 mm step using reference frames from the downstream sensor.

Over a distance of 90 mm, a conventional optical navigation sensor would perform 100 reference frame updates and the total error would be 10*E. The representative embodiment just described would perform only 9 reference frame updates and the total error would be 3*E. However, over a distance of 89.1 mm, total error in a conventional sensor would be 9.95*E (99 reference frame updates) and in the improved sensor would be 4.24*E (18 reference frame updates−9 ×10 mm steps and 9×0.9 mm steps).

In representative embodiments the first photosensor array operates as usual to measure movement. However, in addition, it sends image samples to the second photosensor array. Included with each image sample is a number that encodes the relative order or time order at which the image sample was obtained. When the same image is observed by the second sensor, the current relative position of the first sensor is subtracted from the relative position of the image observed by the second sensor to produce an estimate of the distance between the two sensors. However, since the distance between the two sensors is known, the first sensor can correct its estimated relative position based on the difference between the estimated distance and the known distance between the sensors.

How often sample images are taken is a tradeoff between the amount of uncorrected error and the amount of memory needed to hold the images. More sample images take more memory, but also will reduce the amount of uncorrected error in the measurements produced by the first sensor.

Representative embodiments can operate bi-directionally, rather than. unidirectionally. If the direction of the underlying surface that is being measured begins to move in the opposite direction, the first sensor will notice this. When this happens, the first and second sensors can reverse their roles.

To reduce cost, it is preferable that both photosensor arrays be contained on a single integrated circuit chip. However, it may be that the resultant distance between the photosensor arrays is smaller than is desired. To correct for this, a lens system similar to a pair of binoculars can be used. A pair of binoculars is designed such that the distance between the optical axes of the eyepieces is smaller than the distance between the optical axes of the objective lenses. Binoculars have this property because the optical path of each side of the binocular passes through a pair of prisms. A similar idea can be used to spread the effective distance between the photosensor arrays without requiring a change in the size of the chip containing the photosensor arrays.

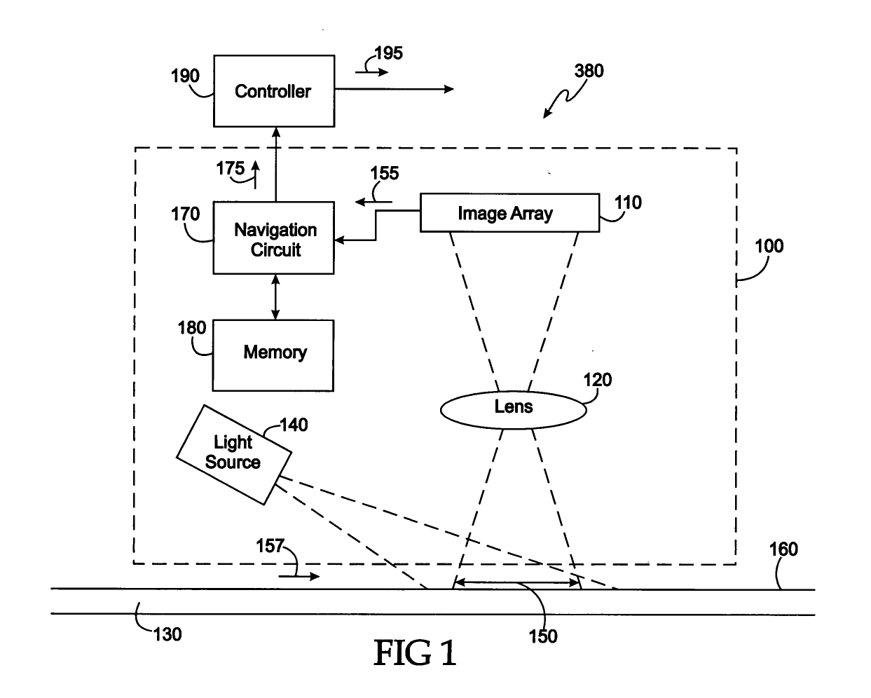

FIG. 1 is a drawing of a block diagram of an optical navigation system 100 as described in various representative embodiments. The optical navigation system 100 can be attached to or a part of another device, as for example a printer 380, an optical mouse 380 or the like. In FIG. 1, the optical navigation system 100 includes an image sensor 110, also referred to herein as a first image sensor 110 and as a first image sensor array 110, an optical system 120, which could be a lens 120 and a lens system 120, for focusing light reflected from a work piece 130, also referred to herein as an object 130 which could be a print media 130 which could be a piece of paper 130 which is also referred to herein as a page 130, onto the first image sensor array 110. Illumination of the print media 130 is provided by light source 140. First image sensor array 110 is preferably a complementary metal-oxide semiconductor (CMOS) image sensor. However, other imaging devices such as a charge coupled-device (CCD), photo diode array or photo transistor array may also be used. Light from light source 140 is reflected from print media 130 and onto first image sensor array 110 via optical system 120. The light source 140 shown in FIG. 1 could be a light emitting diode (LED). However, other light sources 140 can also be used including, for example, a vertical-cavity surface-emitting laser (VCSEL) or other laser, an incandescent light source, a fluorescent light source, or the like. Additionally, it is possible for ambient light sources 140 external to the optical navigation system 100 to be used provided the resulting light level is sufficient to meet the sensitivity threshold requirements of the image sensor array 110.

In operation, relative movement occurs between the work piece 130 and the optical navigation system 100 with images 150 of the surface 160, also referred to herein as a navigation surface 160, of the work piece 130 being periodically taken as the relative movement occurs. By relative movement is meant that movement of the optical navigation system 100, in particular movement of the first image sensor 110, to the right over a stationary navigation surface 160 will result in navigational information equivalent to that which would be obtained if the object 130 were moved to the left under a stationary first image sensor 110. Movement direction 157, also referred to herein as first direction 157, in FIG. 1 indicates the direction that the optical navigation system 100 moves with respect to the stationary work piece 130. The specific movement direction 157 shown in FIG. 1 is for illustrative purposes. Depending upon the application, the work piece 130 and/or the optical navigation system 100 may be capable of movement in multiple directions.

The first image sensor array 110 captures images 150 of the work piece 130 at a rate determined by the application and which may vary from time to time. The captured images 150 are representative of that area of a navigation surface 160, which could be a surface 160 of the piece of paper 130, that is currently being traversed by the optical navigation system 100. The captured image 150 is transferred to a navigation circuit 170 as first image signal 155 and may be stored into a data storage device 180, which could be a memory 180.

The navigation circuit 170 converts information in the first image signal 155 into positional information that is delivered to the controller 190, i.e., navigation circuit 170 generates positional signal 175 and outputs it to controller 190. Controller 190 subsequently generates an output signal 195 that can be used to position a print head in the case of a printer application or other device as needed over the navigation surface 160 of the work piece 130. The navigation circuit 170 and/or the memory 180 can be configured as an integral part of navigation circuit 170 or separate from it. Further, navigation circuit 170 can be implemented as, for example, but not limited to, a dedicated digital signal processor, an application specific integrated circuit, or a combination of logic gates.

The optical navigation sensor must re-reference when the shift between the reference image and the current navigation image is more than a certain number of pixels, typically ⅔ to ½ the sensor width (but could be greater or less than this range). Assuming a ⅛ pixel standard deviation of positional random error, the cumulative error built-up in the system over a given travel will have a standard deviation of ⅛*(N)^{1/2} where N is the number of re-references that occurred. In a typical optical mouse today, an image sensor array 110 with 20×20 pixels is used; and a re-reference action is taken when a positional change of more than 6-pixels is detected. If we assume a 50 micron pixel size, the image sensor 110 will have to re-reference with every 300 micron travel. Based on the relation above, it is apparent that the cumulative error can be reduced by reducing the number of re-references.

In representative embodiments, a large sensor array is used to reduce the number of re-referencing required over a given travel distance. In one embodiment of the present invention, a 40×40 image sensor array 110 is used, with a 50 micron pixel size. The image sensor 110 will re-reference when more than 12-pixel positional changes are detected. In this case, the re-reference distance is 600 micron, which is twice the distance as for a standard sensor. Over the same distance of travel, the 2× increase in re-reference distance will reduce the number of re-reference required by a factor of 2. When compared to a standard 20×20 sensor array, the cumulative error is ⅛*(N/2)^{1/2} or about 71% of the previous cumulative error. Increasing the sensor array size also helps to improve signal-to-noise ratio in the cross-correlation calculation, therefore reduce the random positional error at each re-reference.

While increasing the sensor size improves cumulative positional error, it requires more computational power and memory to implement. It is possible to improve the cumulative error without increasing processing demands on the navigation circuit 170. In another embodiment of the present invention, the sensor array is a rectangular array with increased number of pixels along the direction of most importance. Applications where such design is desirable including printer control, where the paper position along the feeding direction is most critical. As an example, a sensor array of 40×10 may be used to keep the total number of pixels low while enabling the same error reduction to 71% of the previous error along the length of the image sensor 110 as above.

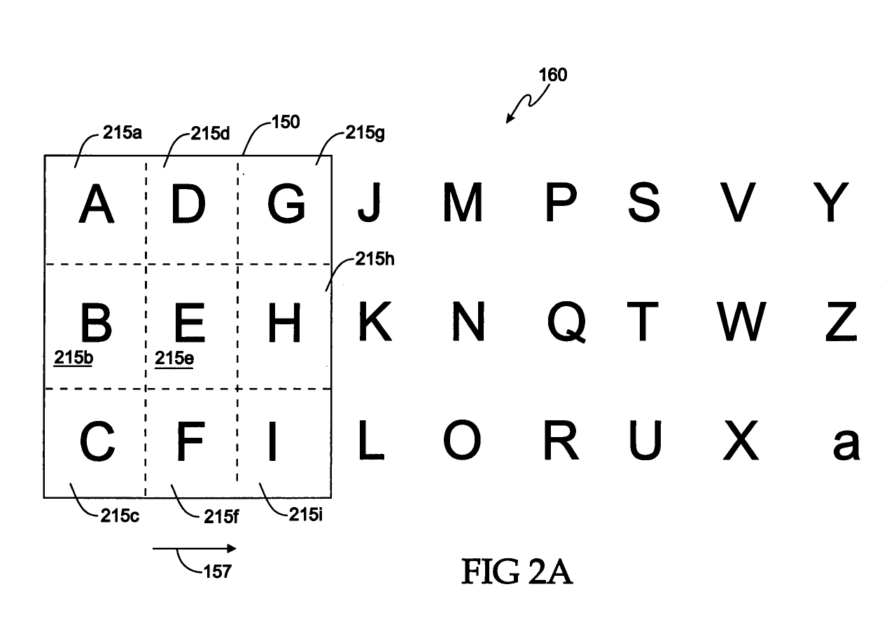

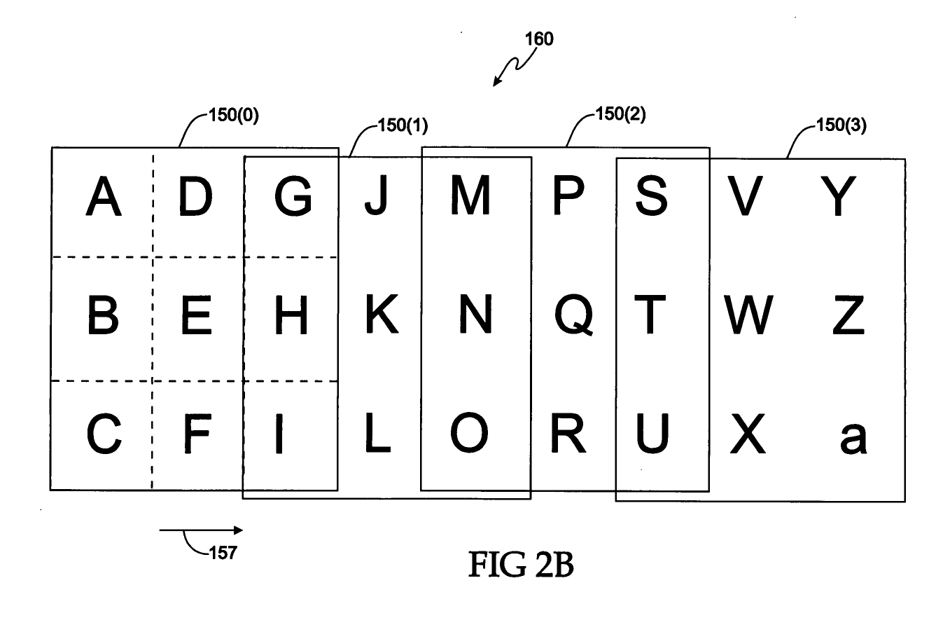

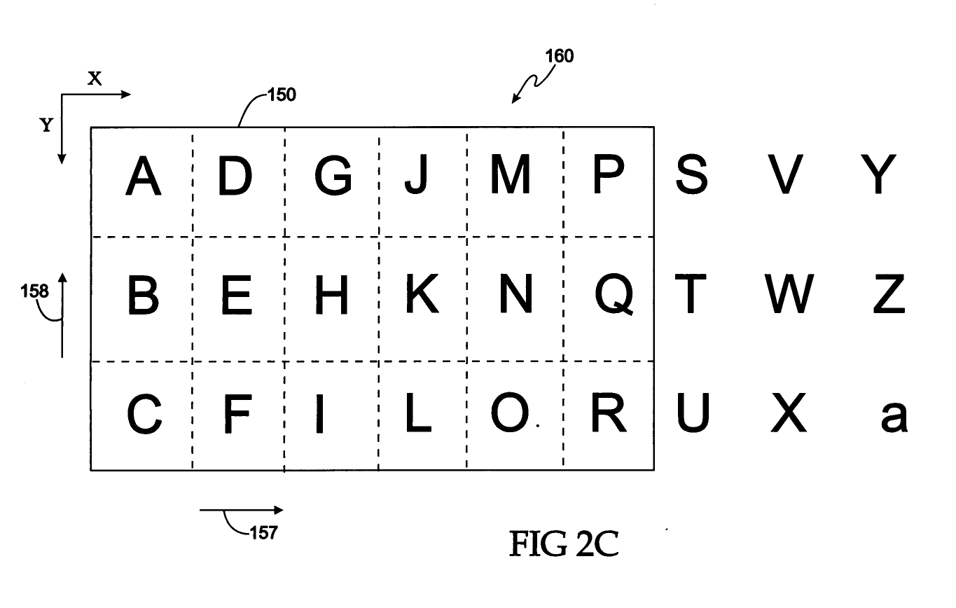

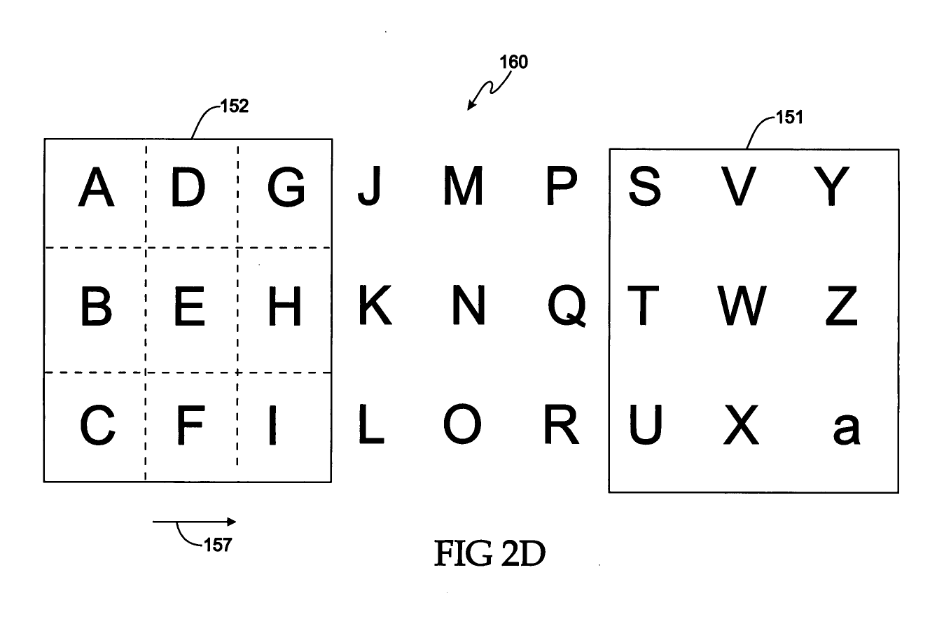

FIG. 2A is a drawing of a navigation surface 160 as described in various representative embodiments. This figure also shows an outline of the image 150, which will later be referred to as first image 151, obtainable by the first image sensor 110 from an area of the navigation surface 160 as described in various representative embodiments. In FIG. 2A, the navigation surface 160 has a distinct surface characteristic or pattern. In this example, for purposes of illustration the surface pattern is represented by the alpha characters A . . . Z and a, also referred to herein as surface patterns A . . . Z and a. As just stated, overlaying the navigation surface 160 is the outline of the image 150 obtainable by overlaying the navigation surface 160 with the first image sensor array 110 to the far left of FIG. 2A. As such, if the first image sensor 110 were positioned as shown in FIG. 2A over the navigation surface 160, the first image sensor 110 would be capable of capturing that area of the surface pattern of the navigation surface 160 represented by surface pattern A . . . I. For the representative embodiment of FIG. 2A, the first image sensor 110 has nine pixels 215, also referred to herein as photosensitive elements 215, whose capture areas are indicated as separated by the dashed vertical and horizontal lines and separately as first pixel 215a overlaying navigation surface pattern A, second pixel 215b overlaying navigation surface pattern B, third pixel 215c overlaying navigation surface pattern C, fourth pixel 215d overlaying navigation surface pattern D, fifth pixel 215e overlaying navigation surface pattern E, sixth pixel 215f overlaying navigation surface pattern F, seventh pixel 215g overlaying navigation surface pattern G, eighth pixel 215h overlaying navigation surface pattern H, and ninth pixel 215i overlaying navigation surface pattern I. For navigational purposes, the captured image 150 represented by alpha characters A . . . I is the reference image 150 which is used to obtain navigational information resulting from subsequent relative motion between the navigation surface 160 and the first image sensor array 110. By relative motion is meant that subsequent movement of the first image sensor 110 to the right (movement direction 157) over a stationary navigation surface 160 will result in navigational information equivalent to that which would be obtained if the navigation surface 160 moved to the right under a stationary first image sensor 110.

FIG. 2B is another drawing of the navigation surface 160 of FIG. 2A. This figure shows the outline of the image 150 obtainable by the first image sensor 110 in multiple positions relative to the navigation surface 160 of FIG. 2A. Also shown in FIG. 2B overlaying the navigation surface 160 is the outline of the image 150 obtainable by overlaying the navigation surface 160 with the first image sensor array 110 in the reference position of FIG. 2A, as well as at positions following three separate movements of the first image sensor 110 to the right (or equivalently following three separate movements of the navigation surface 160 to the left). In FIG. 2A, the reference image is indicated as initial reference image 150(0), and reference images following subsequent movements as image 150(1), as image 150(2), and as image 150(3).

Following the first movement, the image 150 capable of capture by the first image sensor 110 is image 150(1) which comprises surface patterns G-O. Intermediate movements between that of images 150(0) and 150(1) with associated capture of images 150 may also be performed but for ease and clarity of illustration are not shown in FIG. 2B. Regardless, a re-referencing would be necessary with image 150(1) now becoming the new reference image 150, otherwise positional reference information would be lost.

Following the second movement, the image 150 capable of capture by the first image sensor 110 is image 150(2) which comprises surface patterns M-U. Intermediate movements between that of images 150(1) and 150(2) with associated capture of images 150 may also be performed but for ease and clarity of illustration are not shown in FIG. 2B. Regardless, a re-referencing would be necessary with image 150(2) now becoming the new reference image 150, otherwise positional reference information would be lost.

Following the third movement, the image 150 capable of capture by the first image sensor 110 is image 150(3) which comprises surface patterns S-Z and a. Intermediate movements between that of images 150(2) and 150(3) with associated capture of images 150 may also be performed but for ease and clarity of illustration are not shown in FIG. 2B. Regardless, a re-referencing would be necessary with image 150(3) now becoming the new reference image 150, otherwise positional reference information would be lost.

FIG. 2C is yet another drawing of the navigation surface 160 of FIG. 2A. This figure shows an outline of the image 150 obtainable by the first image sensor 110 from an area of a navigation surface 160 as described in various representative embodiments. In one representative embodiment, the image sensor 110 is increased in overall size (i.e., in two dimensions) which increases the movement distance before a re-reference is necessary. In still another representative embodiment as shown in FIG. 2C, the image sensor 110 is increased in size in the movement direction 157 which increases the movement distance before a re-reference is necessary. In FIG. 2C, the image sensor 110 comprises multiple photosensitive elements 215, and the number of photosensitive elements 215 disposed in the first direction 157 is greater than the number of photosensitive elements 215 disposed in a second direction 158. The image sensor 110 is capable of capturing images 150 of successive areas 351 of the surface 160. The areas 351 are located along an axis X parallel to the first direction.

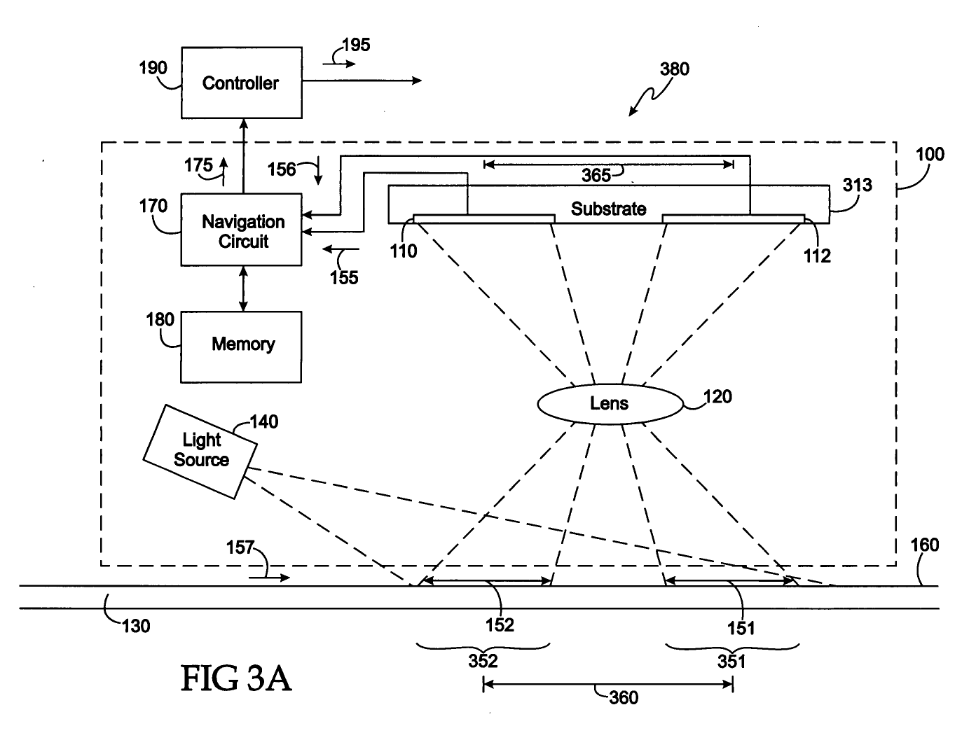

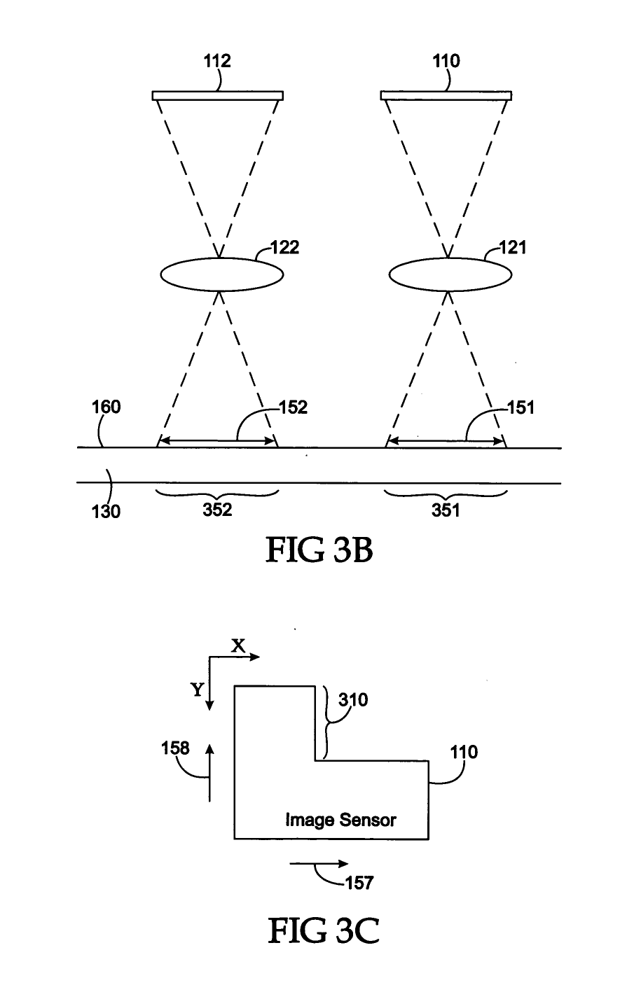

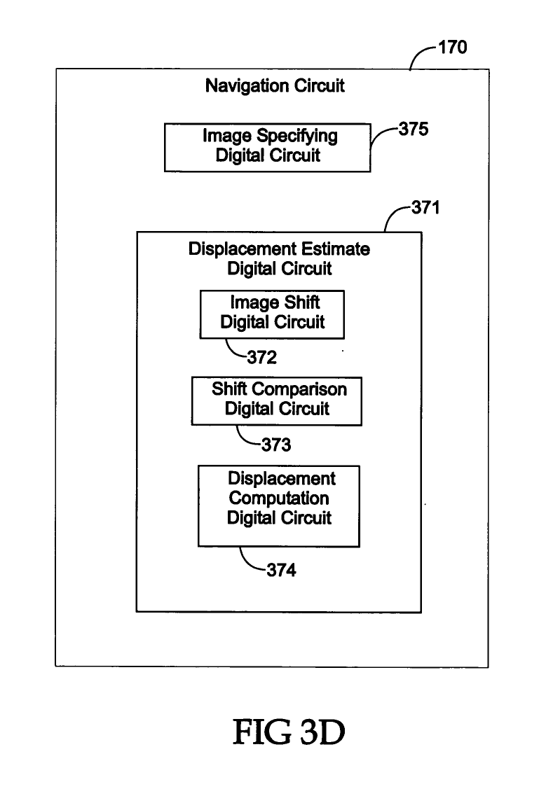

FIG. 2D is still another drawing of the navigation surface 160 of FIG. 2A. This figure shows the outline of the image 150 obtainable by the first image sensor 110 in multiple positions relative to the navigation surface 160 of FIG. 2A. FIG. 2D shows the navigation surface 160 but indicating only image 150(0) and image 150(3). FIG. 2D will be discussed more fully with the discussion of FIG. 3A.

FIG. 3A is a drawing of a block diagram of another optical navigation system 100 as described in various representative embodiments. The optical navigation system 100 can be attached to or a part of another device, as for example a printer 380, an optical mouse 380, another device 380, or the like. In FIG. 3A, the optical navigation system 100 comprises the first image sensor array 110, a second image sensor array 112, also referred to herein as a second image sensor 112, the optical system 120, which could be lens 120 or lens system 120 and which could include one or more prisms or other device or devices for appropriately separating images 151 and 152 as shown in FIG. 3A, for focusing light reflected from work piece 130, which is also referred to herein as object 130 and which could be print media 130 which could be a piece of paper 130 which is also referred to herein as a page 130, onto the first and second image sensors 110,112. As shown in FIG. 3A, first and second image sensors 110,112 are preferably fabricated on a single substrate 313 which could be, for example, a semiconductor substrate 313 which could be silicon, gallium arsenide, or the like. However, fabrication on a single substrate 313 of first and second image sensors 110,112 is not required. Such fabrication would, however, reduce cost.

Illumination of the print media 130 is provided by light source 140. First and second image sensors 110,112 are preferably complementary metallic-oxide semiconductor (CMOS) image sensors. However, other imaging devices such as charge coupled-devices (CCDs), photo diode arrays, or photo transistor arrays may also be used. Light from light source 140 is reflected from print media 130 and onto the image sensors 110,112 via optical system 120. The light source 140 shown in FIG. 3A could be a light emitting diode (LED). However, other light sources 140 can also be used including, for example, a vertical-cavity surface-emitting laser (VCSEL) or other laser, an incandescent light source, a fluorescent light source, or the like. Additionally, it is possible for ambient light sources 140 external to the optical navigation system 100 to be used, provided the resulting light level is sufficient to meet the sensitivity threshold requirements of the first and second image sensors 110,112.

In operation, relative movement occurs between the work piece 130 and the optical navigation system 100 with successive first images 151 paired with successive second images 152 of the surface 160 of the work piece 130 being taken as the relative movement occurs. The images need not be taken at a fixed rate. For example, an optical mouse can change the rate at which it obtains surface images depending on various factors which include an estimate of the speed with which the mouse is being moved. The faster the mouse is moved, the faster images are acquired. At any given time, a first image 151 of the surface 160 is focused by lens system 120 onto the first image sensor 110, and a second image 152 of the surface 160 is focused by lens system 120 onto the second image sensor 112. Re-referencing will be considered whenever sufficient relative movement has occurred between the optical navigation system 100 and the work piece 130 such that the first area 351 of the surface 160 from which a particular first image 151 used as a reference image provides the second image 152 to the second image sensor 112. In other words, re-referencing is considered when a first image 151 from the first area 351 of the surface 160 moves such that the second image 152 captured by the second image sensor 112 matches the referenced first image 151. Also shown in FIG. 3A is a second area 352 of the surface 160 from which the second image 152 is obtained for capture by the second image sensor 112.

Referring back to FIG. 2D, assume that at a particular moment in time the first image 151 captured by the first image sensor 110 is from surface patterns S-Z and a, while the second image 152 captured by the second image sensor 112 is from surface patterns A-I. Re-referencing does not, in fact, need to occur until only a part of the reference first image 151 (surface patterns S-Z and a) remains to be captured by the second image sensor 112.

The image sensor arrays 110,112 capture images 151,152 of the work piece 130 at a rate which as indicated above may be variable. The captured images 151,152 are representative of those areas of the navigation surface 160, which could be a surface 160 of the piece of paper 130, that is currently being traversed by the optical navigation system 100. The captured first image 151 is transferred to the navigation circuit 170 as first image signal 155 and may be stored into the data storage device 180, which could be memory 180. The captured second image 152 is transferred to the navigation circuit 170 as second image signal 156 and may be stored into the data storage device 180.

The navigation circuit 170 converts information in the first and second image signals 155,156 into positional information that is delivered to the controller 190. The navigation circuit 170 is capable of comparing successive second images 152 captured by the second image sensor 112 with the stored first images 151 captured by the first image sensor 110 at an earlier time and obtaining a surface 160 offset distance 360 between compared images 151,152 having a degree of match greater than a preselected value. First and second image sensors 110,112 are separated by a sensor separation distance 365 which may be the same as or different from the value of the image offset distance 360. As indicated above, while the actual distance of travel prior to re-referencing may be as great as the offset distance 360 plus a fraction of the length of that area of the surface 160 projected onto the first image sensor 110. Also, while discussion herein has concentrated on a preferable configuration wherein the first and second image sensors 110,112 are identical, such is not a requirement if appropriate adjustments are made in the navigation circuit 170 when comparing the images 151,152.

The navigation circuit 170 generates positional signal 175 and outputs it to controller 190. Controller 190 subsequently generates an output signal 195 that can be used to position a print head in the case of a printer application or other device as needed over the navigation surface 160 of the work piece 130. Such positioning can be either longitudinal or transverse to the relative direction of motion of the work piece 130. Different sets of image sensors 110,112 may be required for each direction with the possibility of sharing one of the image sensors between the two directions of motion. The navigation circuit 170 and/or the memory 180 can be configured as an integral part of navigation circuit 170 or separate from it. Further navigation circuit 170 can be implemented as, for example, but not limited to, a dedicated digital signal processor, an application specific integrated circuit, or a combination of logic gates. The navigation circuit 170 keeps track of the reference image 150 and the associated surface 160 location.

FIG. 3B is a drawing of a block diagram of part of still another optical navigation system 100 as described in various representative embodiments. In FIG. 3B, a first lens system 121 focuses the first image 151 from the first area 351 of the surface 160 of work piece 130 onto the first image sensor 110, and a second lens system 122 focuses the second image 152 from the second area 352 of the surface 160 of work piece 130 onto the second image sensor 112. First and second image sensors 110,112 can be located on a common substrate or not as appropriate to the application.

FIG. 3C is a drawing of a block diagram of an image sensor 110 as described in various representative embodiments. In FIG. 3C, the image sensor 110 is in the form of an “L”. For this configuration, the elongated section 310 of the image sensor 110, provides additional photosensitive elements 215 for extending the distance moved before a re-reference is needed for movement in the second direction 158. Thus, errors are reduced in both the first and second directions X,Y without creating a full large square array.

FIG. 3D is a drawing of a more detailed block diagram of part of the optical navigation system 100 of FIG. 3A. In FIG. 3C, the navigation circuit 170 comprises a displacement estimate digital circuit 371, also referred to herein as a first digital circuit 371, for determining an estimate for the relative displacement between the image sensor 110 and the object 130 along the axis X obtained by comparing the image 150 captured subsequent to the displacement to the image 150 captured previous to the displacement and an image specifying digital circuit 375, also referred to herein as a fifth digital circuit 375, for specifying which images 150 to use in determining the estimate for the relative displacement between the image sensor 110 and the object 130 along the axis X. A first-in first-out memory 180 could be used in this regard.

The displacement estimate digital circuit 371 comprises an image shift digital circuit 372, also referred to herein as a second digital circuit 372, for performing multiple shifts in one of the images 150, a shift comparison digital circuit 373, also referred to herein as a third digital circuit 373, for performing a comparison, which could be a cross-correlation comparison, between the another image 150 and the shifted multiple images 150, and a displacement computation digital circuit 374, also referred to herein as a fourth digital circuit 374, for using shift information for the shifted image 150 having the largest cross-correlation to compute the estimate of the relative displacement between the image sensor 110 and the object 130 along the axis X.

Some integrated circuits, such as the Agilent ADNS-2030 which is used in optical mice, use a technique called “prediction” that reduces the amount of computation needed for cross correlation. In theory, an optical mouse could work by doing every possible cross-correlation of images (i.e., shift of 1 pixel in all directions, shift of 2 pixels in all directions, etc.) for any given pair of images. The problem with this is that as the number of shifts considered increases, the needed computations increase even faster. For example, for a 9×9 pixel optical mouse there are only 9 possible positions considering a maximum shift of 1 pixel (8 shifted by 1 pixel and one for no movement), but there are 25 possible positions for a maximum considered shift of 2 pixels, and so forth. Prediction decreases the amount of computation by pre-shifting one of the images based on an estimated mouse velocity to attempt to overlap the images exactly. Thus, the maximum amount of shift between the two images is smaller because the shift is related to the error in the prediction process rather than the absolute velocity of the mouse. Consequently, less computation is required. See U.S. Pat. No. 6,433,780 by Gordon et al.

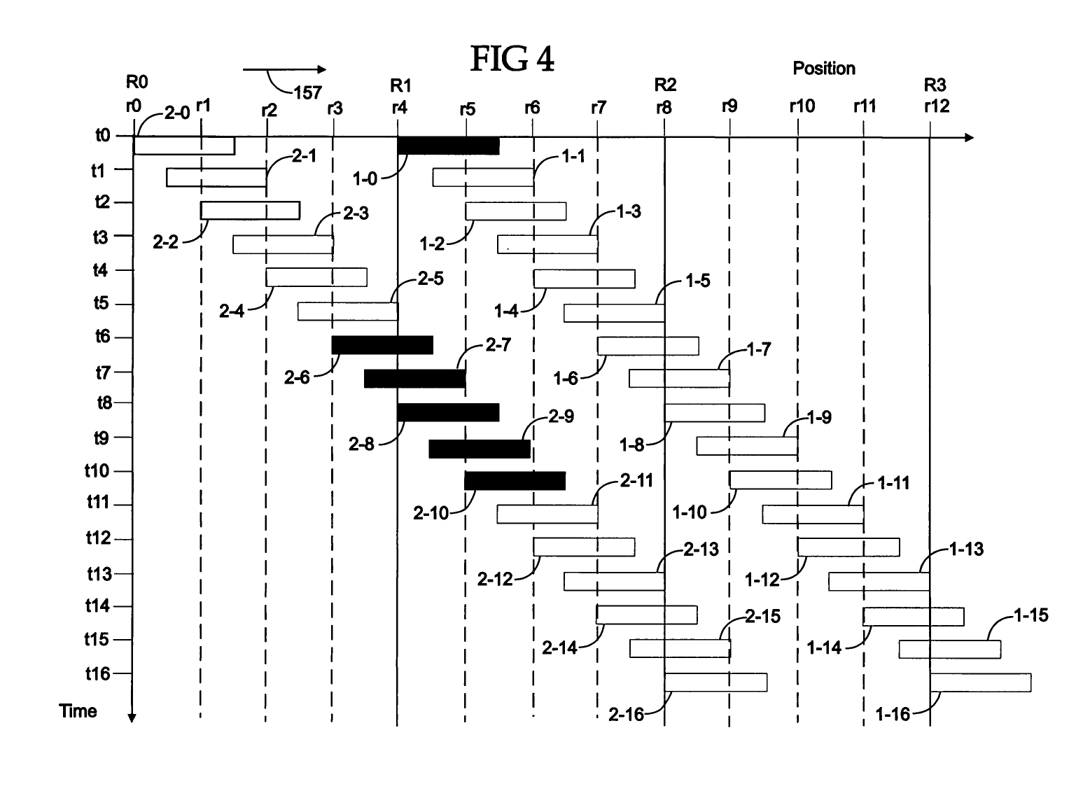

FIG. 4 is a diagram showing placement in time and location of images 151,152 of a surface 160 as described in various representative embodiments. In FIG. 4, time is plotted on the vertical axis with increasing time proceeding down the page, and position on the navigation surface 160 is plotted on the horizontal axis. First and second image sensors 110,112 are assumed to be separated by the distance represented by difference between rl and rO. Further in FIG. 4, first images 151 captured by the first image sensor 110 are indicated as first images 1-0, 1-1, 1-2, . . . , 1-15, 1-16, and second images 152 captured by the second image sensor 112 are indicated as second images 2-0, 2-1, 2-2, . . . , 2-15, 2-16. Pairs of first and second images 151,152 are taken as follows: first image 1-0 is taken at the same time t0 as and paired with second image 2-0, first image 1-1 is taken at the same time t1 as and paired with second image 2-1, first image 1-2 is taken at the same time t2 as and paired with second image 2-2, . . . , first image 1-15 is taken at the same time tl5 as and paired with second image 2-15, and first image 1-16 is taken at the same time tl6 as and paired with second image 2-16.

Prior to initiation of image capture by the first and second image sensors 110,112 no first images 151 are stored in the memory 180. Thus, a comparison between first and second images 151,152 is not possible. Until at least some part of the current captured second image 152 overlaps one of the stored first images 151, re-referencing will occur as discussed with respect to FIG. 1. Such overlap begins to occur at time t5 which corresponds to the optical navigation system 100 having traveled a distance r4. Note that the differential distances r1 to r2, r2 to r3, r4 to r4, . . . are ⅔ the length of the first and second image sensors 110,112 in the direction of motion. Thus for the example of FIG. 4, the optical navigation system 100 has traveled a distance equal to 1⅔ the length of the image sensors 110,112 in the movement direction 157 at the time t5 which corresponds to the left hand edge of first image 1-0 and the right hand edge of second image 2-5 at position r4. Assuming for illustrative purposes, that re-referencing occurs when there is an overlap of only ⅓ of the stored first image 151 and the current second image 152 remaining, re-referencing between first and second images 151,152 cannot occur until at least time t6 which corresponds to a ⅓ overlap of first image 1-0 from first image sensor 110 and second image 2-6 from second image sensor 112. Prior to at least time t6, re-referencing will occur at time t2 corresponding to re-referencing from first image 1-0 to first image 1-2 and at time t4 corresponding to re-referencing from first image 1-2 to first image 1-4.

At time t6 corresponding to an overlap of ⅓ image between stored first image 1-0 and current second image 2-6, re-referencing can occur between the stored first image 1-0 and current second image 2-6 resulting in an increase in accuracy of the re-reference. Assuming the necessity of re-referencing with at least ⅓ image overlap, re-referencing to a second image 152 from the initial stored first image 1-0 can occur up until time tlO at which time the initial stored first image 1-0 is compared to second image 2-10. Thus, instead of having to re-reference every ⅔ length of the image sensors 110,112, after the start-up period re-referencing can be delayed by as much as 3⅓ length of the images taken by image sensors 110,112, again assuming equal lengths in the direction of motion for both the first and second image sensors 110,112 and assuming re-referencing with ⅓ length of image overlap between first and second images 151,152. A larger distance between the first and second image sensors 110,112 results in a larger distance before re-referencing needs to occur.

In addition, the ability to compare a first image 151 of an area of the surface 160 with a second image 152 of the same area of the surface 160 provides the ability to obtain a more precise re-referencing distance. However, under the conditions stated (⅔ length of image sensor overlap) re-referencing between first and second images 151,152 can occur as early as time t6 and as late as time t10 corresponding to a distance of travel of r3 (2 times the length of the image sensor in the direction of travel) to r5 (3−⅓ times the length of the image sensor in the direction of travel).

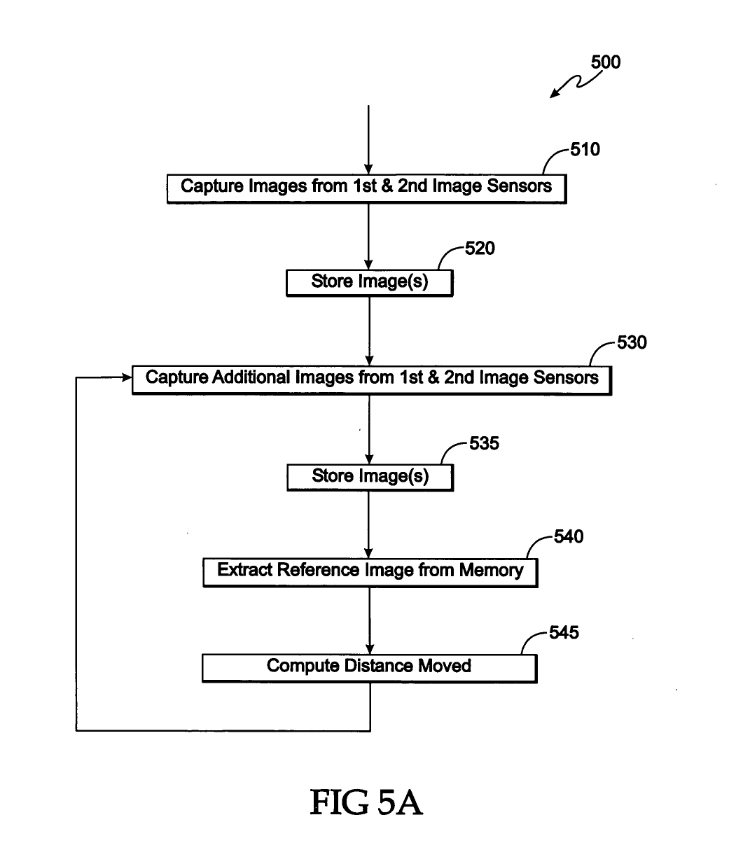

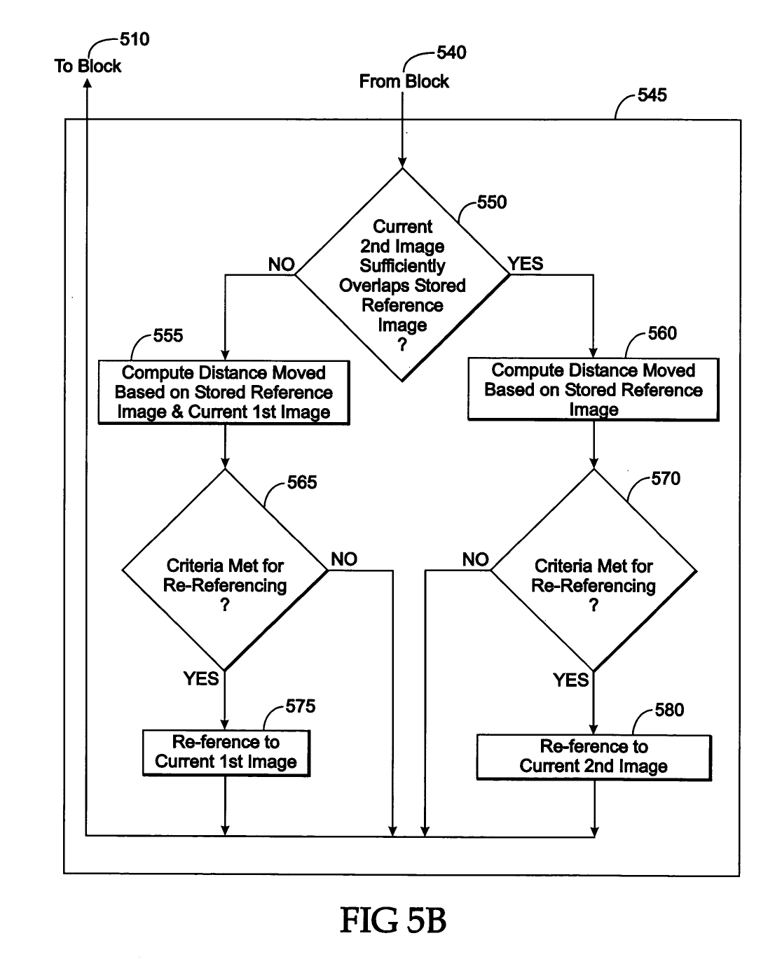

FIG. 5A is a flow chart of a method 500 for using the optical navigation system as described in various representative embodiments. In block 510, a first image 151 of an area of the navigation surface 160 is captured by the first image sensor 110, and a second image 152 of another area of the navigation surface 160 is captured by the second image sensor 112 following placement of the optical navigation system 100 next to the work piece 130. Block 510 then transfers control to block 520.

In block 520, the captured first set of images 151,152 are stored in the data storage device 180. Blocks 510 and 520 are used to load the first set of first and second images 151,152 into the memory 180. Block 520 then transfers control to block 530.

In block 530, an additional set of images 151,152 are captured by the first and second image sensors 110,112. In particular, a first image 151 of an area of the navigation surface 160 is captured by the first image sensor 110, and a second image 152 of another area of the navigation surface 160 is captured by the second image sensor 112. The areas of the navigation surface 160 from which this set of images 151,152 is obtained could be the same area from which the previously captured set of images 151,152 was obtained or a new area. In other words, the images 151,152 are captured at a specified time after the set pair of images 151,152 are captured regardless of whether or not the optical navigation system 100 has been moved relative to the work piece 130. Block 530 then transfers control to block 535.

In block 535, the new captured set of images 151,152 are stored in the data storage device 180. Block 535 then transfers control to block 540.

In block 540, the previous reference image 151 is extracted from the data storage device 180. Block 540 then transfers control to block 545.

In block 545, the navigation circuit 170 compares one of the current captured images 151,152 with the previous reference image 151 to compute the distance moved from the reference image 151. The discussion of FIG. 5B in the following provides more detail regarding this determination. Block 545 then transfers control to block 530.

FIG. 5B is a more detailed flow chart of part of the method of FIG. 5A. In FIG. 5B, control is transferred from block 540 (see FIG. 5A) to block 550 in block 545 (see FIG. 5A). If the current second image 152 and the stored reference image overlap sufficiently, block 550 transfers control to block 560. Otherwise, block 550 transfers control to block 555.

In block 555, the distance moved is computed based on the stored reference first image 151 and the current first image 151. This determination can be performed by comparing a series of shifted current first images 151 to the reference image. The shifted first image 151 best matching the reference image can be determined by applying a cross-correlation function between the reference image and the various shifted first images 151 with the best match having the largest cross-correlation value. Using such techniques, movement distances of less than a pixel length can be resolved. Block 555 then transfers control to block 565.

In block 565, if a preselected image overlap criteria for re-referencing is met, block 565 transfers control to block 575. The criteria for re-referencing generally requires a remaining overlap of approximately ⅔ to ½ of the length of the current first image 151 with the reference image (but could be greater or less than this range). The choice of this criteria is a trade-off between obtaining as large a displacement as possible between re-referencing and ensuring a sufficient image overlap for reliable cross-correlation. Otherwise, block 565 transfers control to block 510.

In block 575, the current first image 151 is designated as the new reference image. Block 575 then transfers control to block 510.

In block 560, the distance moved is computed based on the stored reference image and the current second image 152. This determination can be performed by comparing a series of shifted current second images 152 to the reference image. The shifted second image 152 best matching the reference image can be determined by applying a cross-correlation function between the reference image and the various shifted second images 152 with the best match having the largest cross-correlation value. Using such techniques, movement distances of less than a pixel length can be resolved. Block 560 then transfers control to block 570.

In block 570, if a preselected criteria for re-referencing is met, block 570 transfers control to block 580. The criteria for re-referencing generally requires overlap of approximately ⅔ to ½ of the length of the current second image 152 with the reference image (but could be greater or less than this value) after the center of the current second image 152 has past the center of the reference image, i.e., after the current second image 152 has fully overlapped the reference image but could occur before full overlap occurs. The choice of this criteria is a trade-off between obtaining as large a displacement as possible between re-referencing and ensuring a sufficient image overlap for reliable cross-correlation. An alternative choice would be when the current second image 152 fully overlaps the reference image. This latter choice would provide a larger signal to noise ratio. Otherwise, block 570 transfers control to block 510.

In block 580, the current second image 152 is designated as the new reference image. Block 580 then transfers control to block 510.

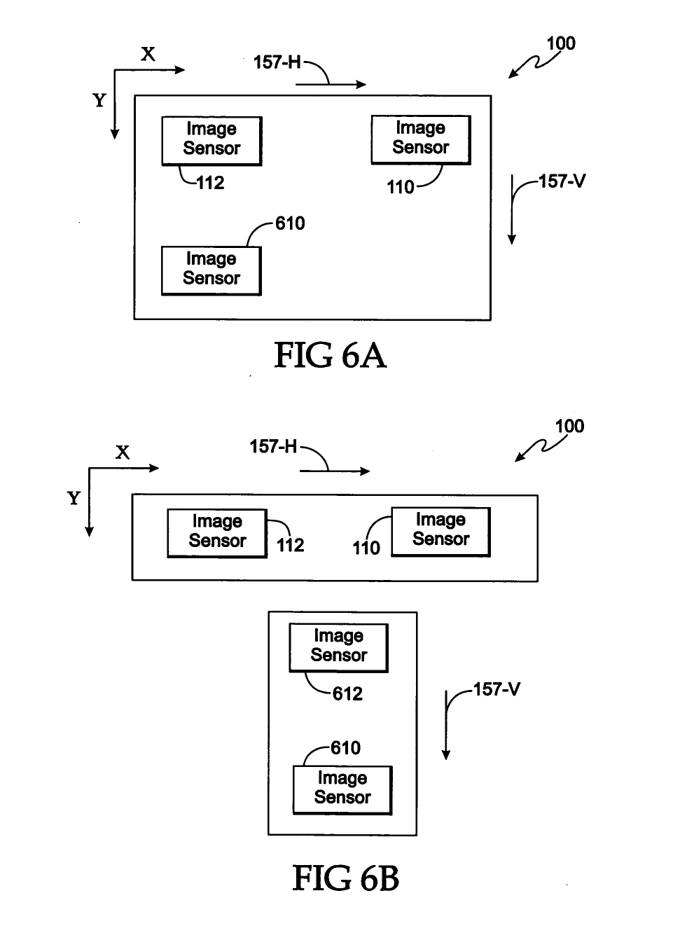

FIG. 6A is a drawing of a block diagram of a three image sensor 110,112,610 optical navigation system 100 as described in various representative embodiments. In FIG. 6A, first and second image sensors 110,112 are configured for navigation in the X direction. Whereas, second image sensor 112 and a third image sensor 610 are configured for navigation in the Y direction. Navigation in the X direction is performed as described above with comparison of images between the first and second image sensors 110,112. Navigation in the Y direction is performed as described above with comparison of images between the third and second image sensors 610,112. Movement in the X direction is shown in FIG. 6A as horizontal direction movement 157-H, and movement in the Y direction is shown as vertical direction movement 157-V.

FIG. 6B is a drawing of a block diagram of a four image sensor 110,112,610,612 optical navigation system 100 as described in various representative embodiments . . . In FIG. 6B, first and second image sensors 110,112 are configured for navigation in the X direction. Whereas, the third image sensor 610 and a fourth image sensor 612 are configured for navigation in the Y direction. Navigation in the X direction is performed as described above with comparison of images between the first and second image sensors 110,112. Navigation in the Y direction is performed as described above with comparison of images between the third and fourth image sensors 610,612. Movement in the X direction is shown in FIG. 6B as horizontal direction movement 157-H, and movement in the Y direction is shown as vertical direction movement 157-V. The addition of the fourth image sensor 612 in FIG. 6B provides the capability of physically decoupling the navigation movement detection of third and fourth image sensors 610,612 from that of first and second image sensors 110,112. Such separate movements may or may not occur at different times. First and second image sensors 110,112 can, for example, track movement of a print head up and down a piece of paper 130 being attached to a roller bar. While third and fourth image sensors 610,612 could, for example, track movement of a print head across a piece of paper 130 being attached to the print head itself. Representative embodiments as described herein offer several advantages over previous techniques. In particular, for a given relative movement direction 157 of the optical navigation system 100 the distance of travel before a re-reference becomes necessary can be increased. This increase in distance decreases the error in the computed position of the optical navigation system.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. An optical navigation system, comprising:
an image sensor capable of optical coupling to a surface of an object, wherein the image sensor comprises multiple photosensitive elements, wherein the number of photosensitive elements disposed in a first direction is greater than the number of photosensitive elements disposed in a second direction, wherein the second direction is perpendicular to the first direction, wherein the image sensor is capable of capturing successive images of areas of the surface, and wherein the areas are located along an axis parallel to the first direction;
a data storage device, wherein the data storage device is capable of storing the captured images; and
a navigation circuit, wherein the navigation circuit comprises a first digital circuit for determining an estimate for the relative displacement between the image sensor and the object along the axis obtained by comparing the images captured at different times.

2. The optical navigation system as recited in claim 1, wherein the first digital circuit comprises:
a second digital circuit to perform multiple shifts in one of the images and a third digital circuit to perform a cross-correlation between the another image and the shifted multiple images; and
a fourth digital circuit to use shift information for the shifted image having the largest cross-correlation for computing the estimate of the relative displacement between the image sensor and the object along the axis.

3. The optical navigation system as recited in claim 1, wherein the navigation circuit further comprises a fifth digital circuit for specifying which images to use in determining the estimate for the relative displacement between the image sensor and the object along the axis.

4. The optical navigation system as recited in claim 1, wherein the optical navigation system is attached to a printer.

5. The optical navigation system as recited in claim 1, wherein the image sensor is elongated in the second direction for a part of the extent of the image sensor in the first direction.

6. An optical navigation system, comprising:
a first image sensor capable of optical coupling to a surface of an object;
a second image sensor capable of optical coupling to the surface separated by a distance in a first direction from the first image sensor, wherein first and second image sensors are capable of capturing images of successive areas of the surface and wherein the areas are located along an axis parallel to the first direction;
a data storage device, wherein a data storage device is capable of storing the captured images; and
a navigation circuit, wherein the navigation circuit comprises a first digital circuit for determining an estimate for the relative displacement between the image sensor and the object along the axis obtained by comparing the images captured subsequent to the displacement to the images captured previous to the displacement.

7. The optical navigation system as recited in claim 6, wherein the first digital circuit comprises:
a second digital circuit to perform multiple shifts in one of the first images and a third digital circuit to perform a cross-correlation between another of the first images and the shifted multiple images; and
a fourth digital circuit to use shift information for the shifted image having the largest cross-correlation for computing the estimate of the relative displacement between the first image sensor and the object along the axis.

8. The optical navigation system as recited in claim 6, wherein the first digital circuit comprises:
a second digital circuit to perform multiple shifts in one of the first images and a third digital circuit to perform a cross-correlation between one of the second images and the shifted multiple images; and
a fourth digital circuit to use shift information for the shifted image having the largest cross-correlation for computing the estimate of the relative displacement between the first image sensor and the object along the axis.

9. The optical navigation system as recited in claim 6, wherein the first image sensor and the second image sensor are fabricated on a common substrate.

10. The optical navigation system as recited in claim 6, wherein the navigation circuit further comprises a fifth digital circuit for specifying which images to use in determining the estimate for the relative displacement between the image sensor and the object along the axis.

11. The optical navigation system as recited in claim 10, wherein the memory is a first-in first-out (FIFO) memory.

12. The optical navigation system as recited in claim 6, further comprising:
a third image sensor capable of optical coupling to the surface, wherein the third image sensor is separated by a distance from the second image sensor in a second direction different from that in which the first image sensor is separated from the second image sensor, wherein the third image sensor is capable of capturing successive images of areas of the surface, wherein the images captured by the third image sensor are associated with the second images captured by the second image sensor, wherein the third image sensor is capable of storing successive images it captures in the data storage device, wherein third and second image sensors are capable of capturing at least one set of images before and one set of images after relative movement between the object and third and second image sensors in a direction different from that in which the first image sensor is separated from the second image sensor, and wherein the navigation circuit is capable of comparing successive images captured by the second image sensor with at least one stored image captured by the third image sensor and obtaining surface offset distance between compared images captured by the third and second image sensors having a degree of match greater than a preselected value.

13. The optical navigation system as recited in claim 6, further comprising:
a fourth image sensor capable of optical coupling to the object; and
a third image sensor capable of optical coupling to the surface, wherein the third image sensor is separated from the fourth image sensor in a second direction different from that in which the first image sensor is separated from the second image sensor, wherein the third image sensor is capable of capturing successive images of areas of the surface, wherein the fourth image sensor is capable of capturing successive images of areas of the surface, wherein the images captured by the third image sensor are associated with the images captured by the fourth image sensor, wherein the third image sensor is capable of storing successive images it captures in the data storage device, wherein third and fourth image sensors are capable of capturing at least one set of images before and one set of images after relative movement between the object and third and fourth image sensors in a direction other than the preselected direction, and wherein the navigation circuit is capable of comparing successive images captured by the fourth image sensor with at least one stored image captured by the third image sensor and obtaining surface offset distance between compared images having a degree of match greater than a preselected value.

14. The optical navigation system as recited in claim 13, wherein distance between the set of first and second image sensors and the set of third and fourth image sensors is variable.

15. The optical navigation system as recited in claim 6, wherein the optical navigation system is attached to a printer.

16. An optical navigation system, comprising:
a large image sensor capable of optical coupling to a surface of an object, wherein the large image sensor comprises an array of pixels having a total active area of at least 2,000 microns by 2,000 microns, wherein the large image sensor is capable of capturing successive images of areas of the surface, wherein a data storage device is capable of storing successive images captured by the first large image sensor, and wherein the large image sensor is capable of capturing at least one image before and one set of images after relative movement between the object and the large image sensor;
the data storage device; and
a navigation circuit, wherein the navigation circuit is capable of comparing successive images captured and stored by the large sensor with at least one stored image captured by the large image sensor and obtaining surface offset distance between compared images having a degree of match greater than a preselected value.

17. The optical navigation system as recited in claim 16, wherein the optical navigation system is attached to a printer.

18. A method, comprising:
capturing a reference image of an area of a surface, wherein the image is captured by an image sensor, wherein the image sensor comprises multiple photosensitive elements, wherein the number of photosensitive elements disposed in a first direction is greater than the number of photosensitive elements disposed in a second direction, wherein the second direction is perpendicular to the first direction, wherein the image sensor is capable of capturing successive images of areas of the surface, and wherein the areas are located along an axis parallel to the first direction;
storing the captured reference image in a data storage device;
capturing a new image by the image sensor;
storing the new image in the data storage device;
comparing the new image with the reference image;
computing the distance moved from the reference image based on the results of the step comparing the new image with the reference image; and
repeating the above steps at least one time.

19. A method, comprising:
capturing a reference first image of an area of a surface, wherein the reference first image is captured by a first image sensor;
capturing an associated second image of another area of the surface, wherein the associated second image is captured by a second image sensor;
storing the reference first image and the associated second image in a data storage device;
capturing a new first image with the first image sensor and a new second image with the second sensor;
storing the captured new first image and the new second image in the data storage device;
comparing at least one of the new first and second images with the reference first image;
computing the distance moved from the reference image based on the results of the step comparing at least one of the new first and second images with the reference image; and
repeating the above steps at least one time.

20. The method as recited in claim 19, the step computing the distance moved from the reference image further comprising:
if the current second image and the stored reference image overlap sufficiently:
computing the distance moved based on the stored reference image and the current second image, and
if a preselected criteria for re-referencing is met, designating the current second image as the new reference image;
Otherwise:
computing the distance moved based on the stored reference first image and the current first image, and
if a preselected image overlap criteria for re-referencing is met, designating the current first image as the new reference image.
